(19) United States
(12) Patent Application Publication
(10) Pub. No.: US 2025/0296822 A1
(43) Pub. Date: Sep. 25, 2025

(54) ELEVATING SYSTEM

(71) Applicant: VERO VERIA CORPORATION, Taipei (TW)

(72) Inventors: CHIEN-TEH HUANG, Taipei (TW); SHAN-HANG CHEN, Taipei (TW)

(21) Appl. No.: 18/818,741

(22) Filed: Aug. 29, 2024

(30) Foreign Application Priority Data
Mar. 22, 2024 (TW) 113110660

(51) Int. Cl. B66F 3/24; B66F 3/22; B66F 3/44

(52) U.S. Cl. CPC B66F 3/247; B66F 3/22; B66F 3/44

(57) ABSTRACT

The present invention is in related to a elevating system, more particularly to a elevating system with the functions of positioning and lifting for parts to be processed. The elevating system has a horizontal frame, a vertical frame, a horizontal reinforcement frame, a first pedestal, a elevating device, a set of adjustment stand, and a set of fixed base.

### CROSS-REFERENCE TO RELATED APPLICATIONS

This application claims priority to Taiwan Application Serial Number 113110660, filed Mar. 22, 2024, which is herein incorporated by reference in its entirety.

### BACKGROUND

### Technical Field

The present invention is in related to an elevating system, more particularly to an elevating system with the functions of positioning and lifting for parts to be processed.

### Related Art

Presently, the elevated floor system in semiconductor factories has been widely applied in electrostatic prevention rooms or clean rooms. In the existing aluminum alloy die-casting process, there are often burrs on the top pin surface of the elevated floor. These burrs prevent tight fitting between elevated floor panels during installation, as well as proper fitting with pedestal frames. Moreover, the burrs do not facilitate installation efficiency and pose safety concerns for workers.

Before, the primary technology relied on manual methods to treat the surfaces of elevated floors after molding. Consequently, workers had to transport batches of elevated floor to processing areas for treatment, which led to discontinuous production processes and low production efficiency. Moreover, each processing step required a significant amount of labor and was time-consuming and labor-intensive.

As for now, the production line for elevated floors has been put into mass-production. However, the positioning of the elevated floor at various processing stations on the production line is not very accurate, leading to issues with precision and yield rate. Therefore, how to overcome the practical problem in prior art, it becomes a very important issue to people skilled in the art.

### SUMMARY

The present invention is an elevating system, which main objective is to solve the problem in the prior arts that the parts to be processed are inaccurately positioned at various processing stations on the production line, resulting in reduced production yield rate and increased production costs.

An elevating system, comprises:
a horizontal frame having a first horizontal beam, a second horizontal beam, a third horizontal beam, and a fourth horizontal beam, wherein two ends of the first horizontal beam are respectively connected with one end of the second horizontal beam and one end of the fourth horizontal beam in an angle, another end of the second horizontal beam being connected with one end of the third horizontal beam in an angle, another end of the third horizontal beam being connected with another end of the fourth horizontal beam in an angle, in order to form a quadrilateral beam;
a vertical frame, having a first vertical beam, a second vertical beam, a third vertical beam, and a fourth vertical beam, wherein one end of the first vertical beam is simultaneously connected with the first horizontal beam and the fourth horizontal beam in 90-degree, one end of the second vertical beam being simultaneously connected with the first horizontal beam and the second horizontal beam in 90-degree, one end of the third vertical beam being simultaneously connected with the second horizontal beam and the third horizontal beam in 90-degree, one end of the fourth beam being simultaneously connected with the third horizontal beam and the fourth horizontal beam in 90-degree;
a first pedestal, disposed on the horizontal frame;
an elevating device, disposed on the first pedestal, and having a first elevating structure and a second elevating structure, which are vertical to the first pedestal respectively and symmetrically distributed on the first pedestal, a driving transmission rod and a driven transmission rod being between the two elevating structures, and the driving transmission rod and the driven transmission rod being connected to the two elevating structures respectively, a power cylinder disposed on the first pedestal transferring power to the driving transmission rod via a transmission crank, the driving transmission rod thus outputting the power to the first elevating structure and the second elevating structure, continuously, the driven transmission rod being driven to lift up and lower down the two elevating structures; and
a set of adjustment stand, having a first adjustment stand, a second adjustment stand, a third adjustment stand, and a fourth adjustment stand, which are individually disposed at four bottom portions of the first vertical beam, the second vertical beam, the third vertical beam, and the fourth vertical beam, and the four bottom portions being firmly connected with a plurality of ends of the first horizontal beam, the second horizontal beam, the third horizontal beam, and the fourth horizontal beam.

Preferably, the two ends of the first horizontal beam are respectively connected with the end of the second horizontal beam and the end of the fourth horizontal beam in the angle, which is 90-degree, the other end of the second horizontal beam being connected with the other end of the third horizontal beam in the angle, which is 90-degree, the other end of the third horizontal beam being connected with the other end of the fourth horizontal beam in the angle, which is 90-degree.

Preferably, the power cylinder is selected from the group consisting of hydraulic cylinder, electric cylinder and pneumatic cylinder.

Preferably, the elevating system further comprises a horizontal reinforcement frame, which comprises a first horizontal reinforcement rib and a second horizontal reinforcement rib, the two horizontal reinforcement ribs being parallel to each other and to the first horizontal beam and the third horizontal beam, and the two horizontal reinforcement ribs being parallel to the second horizontal beam and the fourth horizontal beam, the first pedestal being firmly disposed on the horizontal reinforcement frame; and a set of fixed base, which is connected with the first horizontal beam, the second horizontal beam, the third horizontal beam, and the fourth horizontal beam, one end of the first adjustment stand being disposed at the bottom portion of the first vertical beam, and another end being contacted with ground and connected with the first horizontal beam and the fourth horizontal beam; one end of the second adjustment stand being disposed at the bottom portion of the second vertical beam, and another end being contacted with the ground and connected with the first horizontal beam and the second horizontal beam; one end of the third adjustment stand being disposed at the bottom portion of the third vertical beam, and another end being contacted with the ground and connected with the second horizontal beam and the third horizontal beam; and one end of the fourth adjustment stand being disposed at the bottom portion of the fourth vertical beam, and another end being contacted with the ground and connected with the third horizontal beam and the fourth horizontal beam.

Preferably, the two horizontal reinforcement ribs are vertical to each other and to the first horizontal beam and the third horizontal beam, and the two horizontal reinforcement ribs being parallel to the second horizontal beam and the fourth horizontal beam.

Preferably, the first elevating structure and the second elevating structure respectively have a first pivot outer arm and a first pivot inner arm and a second pivot outer arm and a second pivot inner arm, the first pivot outer arm and the first pivot inner arm being pivotally connected to each other at a first pivot point, in order to achieve the first elevating structure to perform scissor-like movements, the second pivot outer arm and the second pivot inner arm being pivotally connected to each other at a second pivot point, in order to achieve the second elevating structure to perform scissor-like movements, two ends of the driven rod being respectively connected with the first pivot inner arm and the second pivot inner arm, and the first pivot outer arm and the second pivot outer arm, the power cylinder driving the driving transmission rod in order to drive the first pivot inner arm and the second pivot inner arm, so that the first elevating structure and the second elevating structure are able to lift up and lower down simultaneously.

Preferably, the first pivot outer arm has a first pivot outer arm end and a first pivot outer arm movable end, the first pivot outer arm end being pivoted to a first pivot outer arm fixed end, and the first pivot outer arm fixed end being fixed on a first pivot upper plate that is above the first pivot outer arm fixed end, accordingly, the first pivot outer arm fixed end being a pivotal point of the first pivot outer arm, that is to say the first pivot outer arm fixed end is a central point for the first pivot outer arm to swing, the first pivot outer arm movable end being pivoted to a first pivot outer arm movable structure, which moves back and forth in a first lower limit structure fixed on the first pedestal, the first lower limit structure being structured by two vertical plates and a horizontal plate as a n-type structure, wherein two lower ends of the two vertical plates are fixed on the first pedestal, two upper ends of the two vertical plates being fixed on two ends of the horizontal plate, the first pivot outer arm movable structure having a bearing, which rolls on the first pedestal back and forth.

Preferably, the first pivot inner arm has a first pivot inner arm end and a first pivot inner arm movable end, the first pivot inner arm end being pivoted to a first pivot inner arm fixed end, and the first pivot inner arm fixed end being fixed on the first pedestal, accordingly, the first pivot inner arm fixed end being a pivotal point of the first pivot inner arm, that is to say the first pivot inner arm end is a central point for the first pivot inner arm to swing, the first pivot inner arm movable end being pivoted to a first pivot inner arm movable structure, which moves back and forth in a first upper limit structure fixed on the first pivot upper plate, the first upper limit structure being structured by two vertical plates and a horizontal plate as a n-type structure, wherein two upper ends of the two vertical plates are fixed on the first pivot upper plate, and two lower ends of the two vertical plates being fixed on two ends of the horizontal plate, the first pivot inner arm movable structure having a bearing, which rolls on the horizontal plate back and forth.

Preferably, the second pivot outer arm has a second pivot outer arm end and a second pivot outer arm movable end, the second pivot outer arm end being pivoted to a second pivot outer arm fixed end, and the second pivot outer arm fixed end being fixed on a second pivot upper plate that is above the second pivot outer arm fixed end, accordingly, the second pivot outer arm fixed end being a pivotal point of the second pivot outer arm, that is to say the second pivot outer arm fixed end is a central point for the second pivot outer arm to swing, the second pivot outer arm movable end being pivoted to a second pivot outer arm movable structure, which moves back and forth in a second lower limit structure fixed on the first pedestal 4, the second lower limit structure being structured by two vertical plates and a horizontal plate as a n-type structure, wherein two lower ends of the two vertical plates are fixed on the first pedestal, and two upper ends of the two vertical plates being fixed on two ends of the horizontal plate, the second pivot outer arm movable structure having a bearing, which rolls on the first pedestal back and forth.

Preferably, the second pivot inner arm has a second pivot inner arm end and a second pivot inner arm movable end, the second pivot inner arm end being pivoted to a second pivot inner arm fixed end, and the second pivot inner arm fixed end being fixed on the first pedestal, accordingly, the second pivot inner arm fixed end being a pivotal point of the second pivot inner arm, that is to say the second pivot inner arm end is a central point for the second pivot inner arm to swing, the second pivot inner arm movable end being pivoted to a second pivot inner arm movable structure, which moves back and forth in a second upper limit structure fixed on the second pivot upper plate, the second upper limit structure being structured by two vertical plates and a horizontal plate as a n-type structure, wherein two upper ends of the two vertical plates are fixed on the second pivot upper plate, and two lower ends of the two vertical plates being fixed on two ends of the horizontal plate, the second pivot inner arm movable structure having a bearing, which rolls on the horizontal plate back and forth.

Preferably, the elevating system further comprises a set of fixed base, which are a first fixed base, a second fixed base, a third fixed base, and fourth fixed base, one end of the first fixed base being disposed at one side of the first vertical beam, and another end of the first fixed base being contacted with ground and connected with the first horizontal beam and the fourth horizontal beam, one end of the second fixed base being disposed at one side of the second vertical beam, and another end of the second fixed base being contacted with the ground and connected with the first horizontal beam and the second horizontal beam, one end of the third fixed base beings disposed at one side of the third vertical beam, and another end of the third fixed base being contacted with the ground and connected with the second horizontal beam and the third horizontal beam, and one end of the fourth fixed base being disposed at one side of the third vertical beam, and another end of the fourth fixed base being contacted with the ground and connected with the third horizontal beam and the fourth horizontal beam.

Preferably, the elevating system further comprises a plurality of fixed devices, which are a first fixed device, a second fixed device, a third fixed device, and a fourth fixed device, wherein the first fixed device and the second fixed device are respectively disposed on the two first convex blocks of the first elevating processing part bearing seat, and the first elevating processing part bearing seat being above and parallel to the first pivot upper plate, the third fixed device and the fourth fixed device being respectively disposed on the two second convex blocks of the second elevating processing part bearing seat, and the second elevating processing part bearing seat being above and parallel to the second pivot upper plate.

Preferably, each of the fixed devices has a positioning cylinder, a fixed connecting structure, a positioning telescopic rod, and a positioning fixed structure, one end of each of the positioning telescopic rods being telescopic up and down in each of the positioning cylinders, and another end being connected with one side of each of the fixed connecting structures, wherein each of the fixed connecting structures is shaped as a plate, each of the column-type positioning fixed structures being disposed beneath another side of each of the fixed connecting structure.

Preferably, the first fixed device has a first positioning cylinder, a first fixed connecting structure, a first positioning telescopic rod, and a first positioning fixed structure, one end of the first positioning telescopic rod being telescopic up and down in the first positioning cylinder, and another end being connected with one side of the first fixed connecting structure, wherein the first fixed connecting structure is shaped as a plate, the column-type first positioning fixed structure being disposed beneath another side of the first fixed connecting structure, when an elevated floor to be processed is moved to a position where is above the first elevating processing part bearing seat and the second elevating processing part bearing seat, the elevating device being lifted up to dispose the elevated floor to be processed on the first elevating processing part bearing seat and the second elevating processing part bearing seat, after the elevated floor to be processed is positioned, at the same time, the first fixed device and the first positioning telescopic rod also changing a height in accordance with a processing height, and the first positioning fixed structure also pressing against a corner of the elevated floor to be processed.

Preferably, the second fixed device has a second positioning cylinder, a second fixed connecting structure, a second positioning telescopic rod, and a second positioning fixed structure, one end of the second positioning telescopic rod being telescopic up and down in the second positioning cylinder, and another end being connected with one side of the second fixed connecting structure, wherein the second fixed connecting structure is shaped as a plate, the column-type second positioning fixed structure being disposed beneath another side of the second fixed connecting structure, when a elevated floor to be processed is moved to a position where is above the first elevating processing part bearing seat and the second elevating processing part bearing seat, the elevating device being lifted up to dispose the elevated floor to be processed on the first elevating processing part bearing seat and the second elevating processing part bearing seat, after the elevated floor to be processed is positioned, at the same time, the second fixed device and the second positioning telescopic rod also changing a height in accordance with a processing height, and the second positioning fixed structure also pressing against a corner of the elevated floor to be processed.

Preferably, the third fixed device has a third positioning cylinder, a third fixed connecting structure, a third positioning telescopic rod, and a third positioning fixed structure, one end of the third positioning telescopic rod being telescopic up and down in the third positioning cylinder, and another end being connected with one side of the third fixed connecting structure, wherein the third fixed connecting structure is shaped as a plate, the column-type third positioning fixed structure being disposed beneath another side of the third fixed connecting structure, when a elevated floor to be processed is moved to a position where is above the first elevating processing part bearing seat and the second elevating processing part bearing seat, the elevating device being lifted up to dispose the elevated floor to be processed on the first elevating processing part bearing seat and the second elevating processing part bearing seat, after the elevated floor to be processed is positioned, at the same time, the third fixed device and the third positioning telescopic rod also changing a height in accordance with a processing height, and the third positioning fixed structure also pressing against a corner of the elevated floor to be processed.

Preferably, the fourth fixed device has a fourth positioning cylinder, a fourth fixed connecting structure, a fourth positioning telescopic rod, and a fourth positioning fixed structure, one end of the fourth positioning telescopic rod being telescopic up and down in the fourth positioning cylinder, and another end being connected with one side of the fixed connecting structure, wherein the fourth fixed connecting structure is shaped as a plate, the column-type fourth positioning fixed structure being disposed beneath another side of the fourth fixed connecting structure, when an elevated floor to be processed is moved to a position where is above the first elevating processing part bearing seat and the second elevating processing part bearing seat, the elevating device being lifted up to dispose the elevated floor to be processed on the first elevating processing part bearing seat and the second elevating processing part bearing seat, after the elevated floor to be processed is positioned, at the same time, the fourth fixed device and the fourth positioning telescopic rod changing a height in accordance with a processing height, and the fourth positioning fixed structure also pressing against a corner of the elevated floor to be processed.

Preferably, the elevating system further comprises a second pedestal, which is disposed on the first vertical beam, the second vertical beam, the third vertical beam, and the fourth vertical beam, the first vertical beam being simultaneously and firmly connected with the first horizontal beam and the fourth horizontal beam the second vertical beam being simultaneously and firmly connected with the first horizontal beam and the second horizontal beam, the third vertical beam being simultaneously and firmly connected with the second horizontal beam and the third horizontal beam, the fourth vertical beam being simultaneously and firmly connected with the third horizontal beam and the fourth horizontal beam, the second pedestal also having an open, which allows the elevating device going through when the elevating device is being lifted up to a certain height and lowered down to the first pedestal.

Preferably, the first elevating processing part bearing seat and the second elevating processing part bearing seat are parallel to each other.

Preferably, the first elevating processing part bearing seat and the second elevating processing part bearing seat are respectively fixed to two positions where are above the first pivot upper plate and the second pivot upper plate.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 illustrates a schematic 3-D view of an elevating system applied to a production line of the present invention;

FIG. 2 illustrates a schematic front view of the elevating system applied to the production line of the present invention;

FIG. 3 illustrates a schematic front 3-D view of the lift system of the present invention;

FIG. 4 illustrates a schematic view, in a different angle of the elevating system of the present invention;

FIG. 5 illustrates a schematic view with another different angle of the elevating system of the present invention; and

FIG. 6 illustrates a schematic 3-D view of an elevating system according to another embodiment of the present invention.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

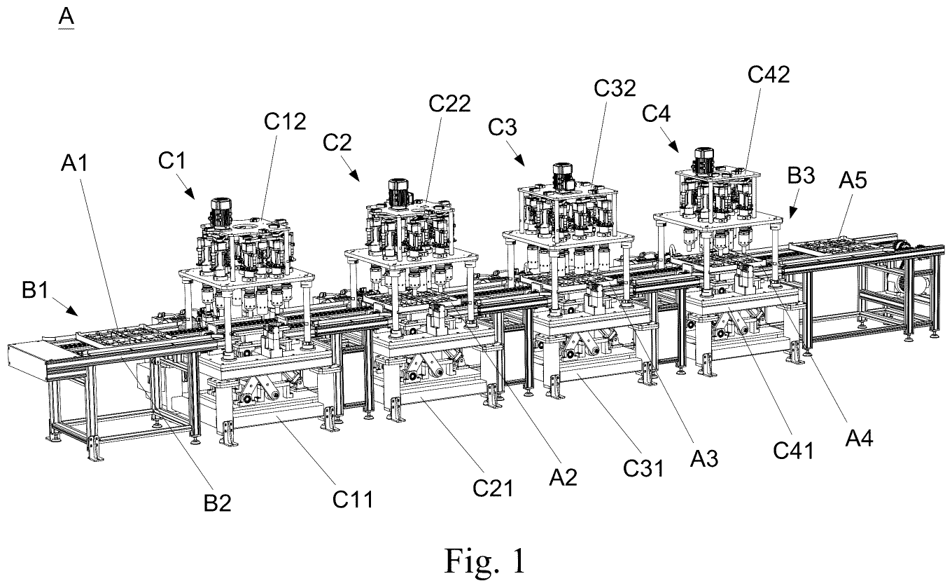

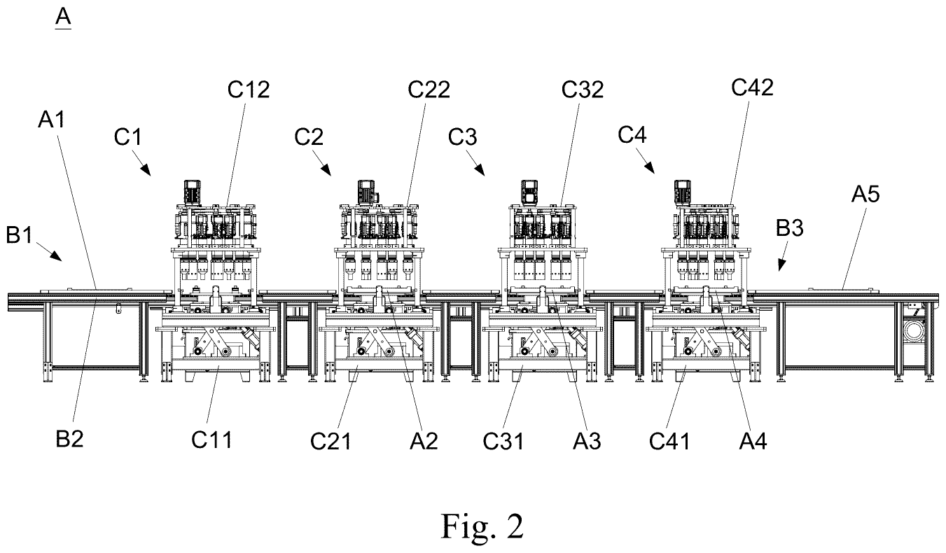

Please refer to FIG. 1 and FIG. 2, which illustrates a schematic 3-D view of an elevating system applied to a production line of the present invention and a schematic front view of the elevating system applied to the production line of the present invention. As shown in FIG. 1, it is a semiconductor elevated floor production line A, and includes a material entrance B1, a first processing station C1, a second processing station C2, a third processing station C3, a fourth processing station C4, and a material outlet B3. A plurality of pieces to be processed, such as a first elevated floor A1, a second elevated floor A2, a third elevated floor A3, and a fourth elevated floor A4, are respectively prepared or being transported to the material entrance B1 on a conveyor belt B2, the first processing station C1, the second processing station C2, the third processing station C3, and the fourth processing station C4 for processing. A fifth elevated floor A5 is processed and waiting in front of the material outlet B3. If the elevated floors are processed at those processing stations, those semiconductor elevated floors are respectively raised by a first elevating system C11, a second elevating system C21, a third elevating system C31, and a fourth elevating system C41 from below thereof, so as to keep distances from the conveyor belt B2. It is to facilitate that of the processing to the semiconductor elevated floors of a first machine tool C12, a second machine tool C22, a third machine tool C32, and a fourth machine tool C42. Hence, the elevating system of the present invention will be described based on the operations of the aforesaid production line.

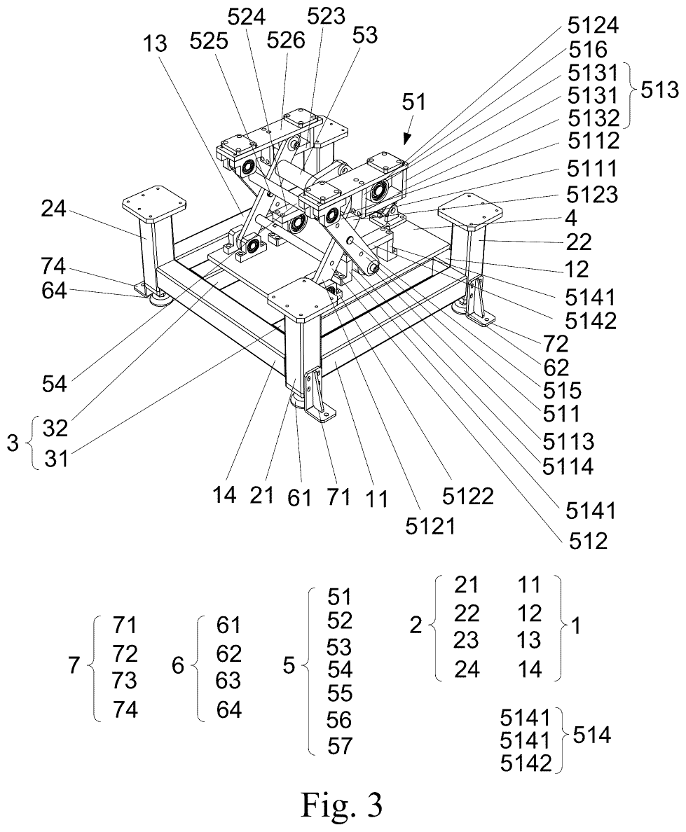

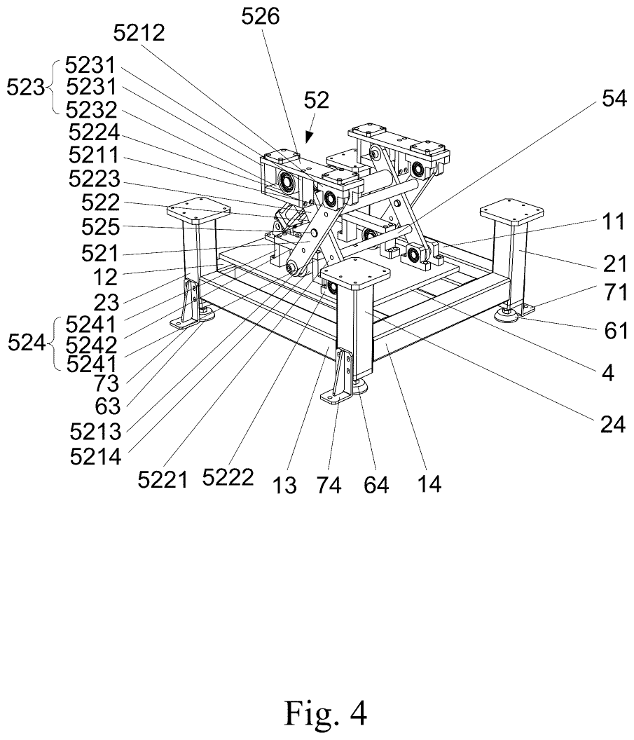

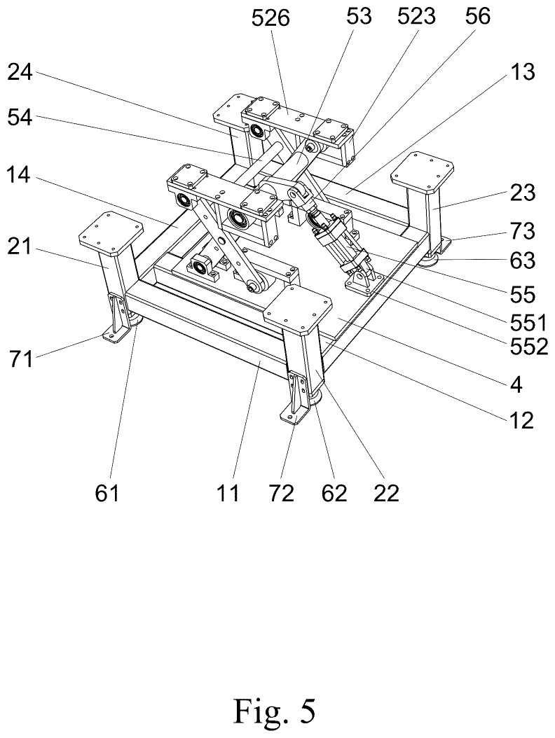

Please to FIG. 3 to FIG. 5, which illustrate a schematic front 3-D view of the lift system of the present invention, a schematic view, in a different angle of the elevating system of the present invention and a schematic view with another different angle of the elevating system of the present invention. The elevating system includes a horizontal frame 1, a vertical frame 2, a horizontal reinforcement frame 3, a first pedestal 4, an elevating device 5, a set of adjustment stand 6, and a set of fixed base 7.

The horizontal frame 1 includes a first horizontal beam 11, a second horizontal beam 12, a third horizontal beam 13, and a fourth horizontal beam 14, wherein two ends of the first horizontal beam 11 are respectively connected with one end of the second horizontal beam 12 and one end of the fourth horizontal beam 14 in an angle, which is 90-degree; another end of the second horizontal beam 12 is connected with one end of the third horizontal beam 13 in an angle, which is 90 degree; another end of the third horizontal beam 13 is connected with another end of the fourth horizontal beam 14 in an angle, which is 90-degree. Hence, a quadrilateral beam has been formed.

The vertical frame 2 includes a first vertical beam 21, a second vertical beam 22, a third vertical beam 23, and a fourth vertical beam 24, wherein one end of the first vertical beam 21 is simultaneously connected with the first horizontal beam 11 and the fourth horizontal beam 14 in an angle, which is 90-degree, one end of the second vertical beam 22 is simultaneously connected with the first horizontal beam 11 and the second horizontal beam 12 in an angle, which is 90-degree, one end of the third vertical beam 23 is simultaneously connected with the second horizontal beam 12 and the third horizontal beam 13 in an angle, which is 90-degree, one end of the fourth beam 24 is simultaneously connected with the third horizontal beam 13 and the fourth horizontal beam 14 in an angle, which is 90-degree as well.

The horizontal reinforcement frame 3 includes a first horizontal reinforcement rib 31 and a second horizontal reinforcement rib 32. The two horizontal reinforcement ribs 31, 32 are parallel to each other and to the first horizontal beam 11 and the third horizontal beam 13, further, the two horizontal reinforcement ribs 31, 32 are parallel to the second horizontal beam 12 and the fourth horizontal beam 14 as well. For the preferred embodiment, the two horizontal reinforcement ribs 31, 32 parallel to the first horizontal beam 12 and the third horizontal beam 13 is adopted. On the other hand, the two horizontal reinforcement ribs 31, 32 are vertical to each other will be another option.

The first pedestal 4 is thus disposed on the horizontal reinforcement frame 3 of the horizontal frame 1.

The elevating device 5 is disposed on the first pedestal 4, and includes a first elevating structure 51 and a second elevating structure 52, which are vertical to the first pedestal 4 respectively and symmetrically distributed on the first pedestal 4. As for the present embodiment, the first elevating structure 51 and the second elevating structure 52 respectively have a first pivot outer arm 511 and a first pivot inner arm 512 and a second pivot outer arm 521 and a second pivot inner arm 522. As to the present embodiment, the first pivot outer arm 511 has a first pivot outer arm end 5111 and a first pivot outer arm movable end 5113, and the first pivot inner arm 512 has a first pivot inner arm end 5121 and a first pivot inner arm movable end 5123. The first pivot outer arm end 5111 is pivoted to a first pivot outer arm fixed end 5112, and the first pivot outer arm fixed end 5112 is fixed on a first pivot upper plate 516 that is above the first pivot outer arm fixed end 5112. Accordingly, the first pivot outer arm fixed end 5112 is a pivotal point of the first pivot outer arm 511. It means the first pivot outer arm fixed end 5112 is a central point for the first pivot outer arm 511 to swing. The first pivot outer arm movable end 5113 is pivoted to a first pivot outer arm movable structure 5114, which moves back and forth in a first lower limit structure 514 fixed on the first pedestal 4. The first lower limit structure 514 is structured by two vertical plates 5141 and a horizontal plate 5142 as a n-type structure, wherein two lower ends of the two vertical plates 5141 are fixed on the first pedestal 4, and two upper ends of the two vertical plates 5141 are fixed on two ends of the horizontal plate 5142. The first pivot outer arm movable structure 5114 has a bearing, which rolls on the first pedestal 4 back and forth. The first pivot inner arm end 5121 is pivoted to a first pivot inner arm fixed end 5122, and the first pivot inner arm fixed end 5122 is fixed on the first pedestal 4. Accordingly, the first pivot inner arm fixed end 5122 is a pivotal point of the first pivot inner arm 512. It means that the first pivot inner arm end 5122 is a central point for the first pivot inner arm 512 to swing. The first pivot inner arm movable end 5123 is pivoted to a first pivot inner arm movable structure 5124, which moves back and forth in a first upper limit structure 513 fixed on the first pivot upper plate 516. The first upper limit structure 513 is structured by two vertical plates 5131 and a horizontal plate 5132 as a n-type structure, wherein two upper ends of the two vertical plates 5131 are fixed on the first pivot upper plate 516, and two lower ends of the two vertical plates 5131 are fixed on two ends of the horizontal plate 5132. The first pivot inner arm movable structure 5124 has a bearing, which rolls on the horizontal plate back and forth. The first pivot outer arm 511 and the first pivot inner arm 512 are pivotally connected to each other at a first pivot point 515, in order to achieve the first elevating structure 51 to perform scissor-like movements. As to the present embodiment, the second pivot outer arm 521 has a second pivot outer arm end 5211 and a second pivot outer arm movable end 5213, and the second pivot inner arm 522 has a second pivot inner arm end 5221 and a second pivot inner arm movable end 5223. The second pivot outer arm end 5211 is pivoted to a second pivot outer arm fixed end 5212, and the second pivot outer arm fixed end 5212 is fixed on a second pivot upper plate 526 that is above the second pivot outer arm fixed end 5212. Accordingly, the second pivot outer arm fixed end 5212 is a pivotal point of the second pivot outer arm 521. It means the second pivot outer arm fixed end 5212 is a central point for the second pivot outer arm 521 to swing. The second pivot outer arm movable end 5213 is pivoted to a second pivot outer arm movable structure 5214, which moves back and forth in a second lower limit structure 524 fixed on the first pedestal 4. The second lower limit structure 524 is structured by two vertical plates 5241 and a horizontal plate 5242 as a n-type structure, wherein two lower ends of the two vertical plates 5241 are fixed on the first pedestal 4, and two upper ends of the two vertical plates 5241 are fixed on two ends of the horizontal plate 5242. The second pivot outer arm movable structure 5214 has a bearing, which rolls on the first pedestal 4 back and forth. The second pivot inner arm end 5221 is pivoted to a second pivot inner arm fixed end 5222, and the second pivot inner arm fixed end 5222 is fixed on the first pedestal 4. Accordingly, the second pivot inner arm fixed end 5222 is a pivotal point of the second pivot inner arm 522. It means that the second pivot inner arm end 5222 is a central point for the second pivot inner arm 522 to swing. The second pivot inner arm movable end 5223 is pivoted to a second pivot inner arm movable structure 5224, which moves back and forth in a second upper limit structure 523 fixed on the second pivot upper plate 526. The second upper limit structure 523 is structured by two vertical plates 5231 and a horizontal plate 5232 as a n-type structure, wherein two lower ends of the two vertical plates 5231 are fixed on the second pivot upper plate 526, and two upper ends of the two vertical plates 5231 are fixed on two ends of the horizontal plate 5232. The second pivot inner arm movable structure 5224 has a bearing, which rolls on the horizontal plate 5232 back and forth. The second pivot outer arm 521 and the second pivot inner arm 522 are pivotally connected to each other at a second pivot point 525, in order to achieve the second elevating structure 52 to perform scissor-like movements. There are a driving transmission rod 53 and a driven transmission rod 54 between the two elevating structures 51, 52, and the driving transmission rod 53 and the driven transmission rod 54 are connected to the two elevating structures 51, 52 respectively. A power cylinder 55 disposed on the first pedestal 4 transfers power to the driving transmission rod 53 via a transmission crank 56. The driving transmission rod 53 thus outputs the power to the first elevating structure 51 and the second elevating structure 52. Continuously, the driven transmission rod 54 is driven to lift up and lower down the two elevating structures 51, 52.

The set of adjustment stand 6 includes a first adjustment stand 61, a second adjustment stand 62, a third adjustment stand 63, and a fourth adjustment stand 64, which are individually disposed at four bottom portions of the first vertical beam 21, the second vertical beam 22, the third vertical beam 23, and the fourth vertical beam 24. In the embodiment, one end of the first adjustment stand 61 is disposed at the bottom portion of the first vertical beam 21, and another end is contacted with the ground and connected with the first horizontal beam 11 and the fourth horizontal beam 14; one end of the second adjustment stand 62 is disposed at the bottom portion of the second vertical beam 22, and another end is contacted with the ground and connected with the first horizontal beam 11 and the second horizontal beam 12; one end of the third adjustment stand 63 is disposed at the bottom portion of the third vertical beam 23, and another end is contacted with the ground and connected with the second horizontal beam 12 and the third horizontal beam 13; and one end of the fourth adjustment stand 64 is disposed at the bottom portion of the fourth vertical beam 24, and another end is contacted with the ground and connected with the third horizontal beam 13 and the fourth horizontal beam 14.

The set of fixed base 7 includes a first fixed base 71, a second fixed base 72, a third fixed base 73, and fourth fixed base 74, which are individually disposed at four sides of the first vertical beam 21, the second vertical beam 22, the third vertical beam 23, and the fourth vertical beam 24 and connected with the first horizontal beam 11, the second horizontal beam 12, the third horizontal beam 13, and the fourth horizontal beam 14 respectively. In the embodiment, one end of the first fixed base 71 is disposed at one side of the first vertical beam 21, and another end of the first fixed base 71 is contacted with the ground and connected with the first horizontal beam 11 and the fourth horizontal beam 14; one end of the second fixed base 72 is disposed at one side of the second vertical beam 22, and another end of the second fixed base 72 is contacted with the ground and connected with the first horizontal beam 11 and the second horizontal beam 12; one end of the third fixed base 73 is disposed at one side of the third vertical beam 23, and another end of the third fixed base 73 is contacted with the ground and connected with the second horizontal beam 12 and the third horizontal beam 13; and one end of the fourth fixed base 74 is disposed at one side of the third vertical beam 24, and another end of the fourth fixed base 74 is contacted with the ground and connected with the third horizontal beam 13 and the fourth horizontal beam 14.

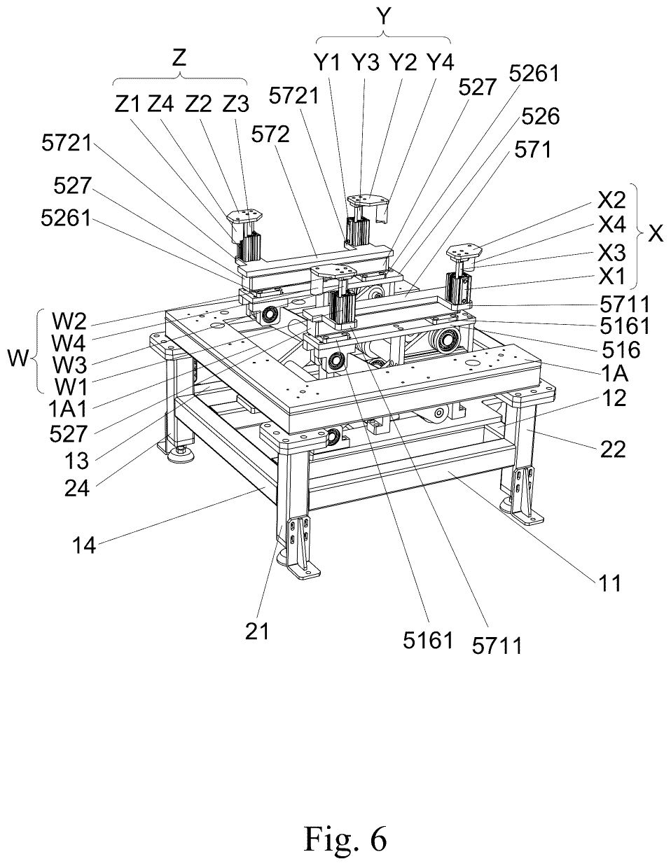

With reference to FIG. 6, which illustrates a schematic 3-D view of a view angle of another embodiment of the elevating system of the present invention. The elevating system has the following descriptions.

A second pedestal 1A, which is disposed on the first vertical beam 21, the second vertical beam 22, the third vertical beam 23, and the fourth vertical beam 24. The first vertical beam 22 is simultaneously and firmly connected with the first horizontal beam 11 and the fourth horizontal beam 14. The second vertical beam 22 is simultaneously and firmly connected with the first horizontal beam 11 and the second horizontal beam 12. The third vertical beam 23 is simultaneously and firmly connected with the second horizontal beam 12 and the third horizontal beam 13. The fourth vertical beam 24 is simultaneously and firmly connected with the third horizontal beam 13 and the fourth horizontal beam 14. The second pedestal 1A also includes an open 1A1, which allows the elevating device 5 going through when the elevating device 5 is being lifted up to a certain height and lowered down to the first pedestal 4. Two connecting pedestals 527 are respectively disposed on two fixed plates 5161 and two fixed plates 5261, and then a first elevating processing part bearing seat 571 and a second elevating processing part bearing seat 572 are individually and firmly fixed on the two connecting pedestals 572, wherein a first convex block 5711 and a second convex block 5721 are respectively protruded from the outer sides of both ends of the first elevating processing part bearing seat 571 and the second elevating processing part bearing seat 572.

A plurality of fixed devices have a first fixed device W, a second fixed device X, a third fixed device Y, and a fourth fixed device Z, wherein the first fixed device W and the second fixed device X are respectively disposed on the two first convex blocks 5711 of the first elevating processing part bearing seat 571, and the first elevating processing part bearing seat 571 is above and parallel to the first pivot upper plate 516, and the third fixed device Y and the fourth fixed device Z are respectively disposed on the two second convex blocks 5721 of the second elevating processing part bearing seat 572, and the second elevating processing part bearing seat 572 is above and parallel to the second pivot upper plate 526. The first elevating processing part bearing seat 571, the second elevating processing part bearing seat 572 and the transmission direction of the conveyor belt B2, shown in FIG. 1 and FIG. 2, are parallel to each other. The first fixed device W includes a first positioning cylinder W1, a first fixed connecting structure W2, a first positioning telescopic rod W3, and a first positioning fixed structure W4. One end of the first positioning telescopic rod W3 is telescopic up and down in the first positioning cylinder W1, and another end is connected with one side of the first fixed connecting structure W2, wherein the first fixed connecting structure W2 is shaped as a plate. The column-type first positioning fixed structure W4 is disposed beneath another side of the first fixed connecting structure W2. When an elevated floor to be processed is moved to a position where is above the first elevating processing part bearing seat 571 and the second elevating processing part bearing seat 572, the elevating device 5 is lifted up to dispose the elevated floor to be processed on the first elevating processing part bearing seat 571 and the second elevating processing part bearing seat 572. After the elevated floor to be processed is positioned, at the same time, the first fixed device W and the first positioning telescopic rod W3 also change a height in accordance with a processing height, and the first positioning fixed structure W4 will also press against a corner of the elevated floor to be processed. The second fixed device X includes a second positioning cylinder X1, a second fixed connecting structure X2, a second positioning telescopic rod X3, and a second positioning fixed structure X4. One end of the second positioning telescopic rod X3 is telescopic up and down in the second positioning cylinder X1, and another end is connected with one side of the second fixed connecting structure X2, wherein the second fixed connecting structure X2 is shaped as a plate. The column-type second positioning fixed structure X4 is disposed beneath another side of the second fixed connecting structure X2. When an elevated floor to be processed is moved to a position where is above the first elevating processing part bearing seat 571 and the second elevating processing part bearing seat 572, the elevating device 5 is lifted up to dispose the elevated floor to be processed on the first elevating processing part bearing seat 571 and the second elevating processing part bearing seat 572. After the elevated floor to be processed is positioned, at the same time, the second fixed device X and the second positioning telescopic rod X3 also change a height in accordance with a processing height, and the second positioning fixed structure X4 will also press against a corner of the elevated floor to be processed. The third fixed device Y includes a third positioning cylinder Y1, a third fixed connecting structure Y2, a third positioning telescopic rod Y3, and a third positioning fixed structure Y4. One end of the third positioning telescopic rod Y3 is telescopic up and down in the third positioning cylinder Y1, and another end is connected with one side of the third fixed connecting structure Y2, wherein the third fixed connecting structure Y2 is shaped as a plate. The column-type third positioning fixed structure Y4 is disposed beneath another side of the third fixed connecting structure Y2. When an elevated floor to be processed is moved to a position where is above the first elevating processing part bearing seat 571 and the second elevating processing part bearing seat 572, the elevating device 5 is lifted up to dispose the elevated floor to be processed on the first elevating processing part bearing seat 571 and the second elevating processing part bearing seat 572. After the elevated floor to be processed is positioned, at the same time, the third fixed device Y and the third positioning telescopic rod Y3 also change a height in accordance with a processing height, and the third positioning fixed structure Y4 will also press against a corner of the elevated floor to be processed. The fourth fixed device Z includes a fourth positioning cylinder Z1, a fourth fixed connecting structure Z2, a fourth positioning telescopic rod Z3, and a fourth positioning fixed structure Z4. One end of the fourth positioning telescopic rod Z3 is telescopic up and down in the fourth positioning cylinder Z1, and another end is connected with one side of the fixed connecting structure Z2, wherein the fourth fixed connecting structure Z2 is shaped as a plate. The column-type fourth positioning fixed structure Z4 is disposed beneath another side of the fourth fixed connecting structure Z2. When an elevated floor to be processed is moved to a position where is above the first elevating processing part bearing seat 571 and the second elevating processing part bearing seat 572, the elevating device 5 is lifted up to dispose the elevated floor to be processed on the first elevating processing part bearing seat 571 and the second elevating processing part bearing seat 572. After the elevated floor to be processed is positioned, at the same time, the fourth fixed device Z and the fourth positioning telescopic rod Z3 also change a height in accordance with a processing height, and the fourth positioning fixed structure Z4 will also press against a corner of the elevated floor to be processed.

According to the above descriptions, the elevating system of the present invention has the following advantages:
1. The elevating system can be applied to any panel production line, and can be unlimitedly expanded to various types of processing stations on the production line.
2. Various processing can be carried out precisely. In addition to increasing the yield, it can also increase production efficiency and reduce production costs.

Although the present disclosure is disclosed in the foregoing embodiments, it is not intended to limit the present disclosure. Changes and modifications made without departing from the spirit and scope of the present disclosure belong to the scope of the claims of the present disclosure. The scope of protection of the present disclosure should be construed based on the following claims.

What is claimed is:

1. An elevating system, comprising:
a horizontal frame (1), having a first horizontal beam (11), a second horizontal beam (12), a third horizontal beam (13), and a fourth horizontal beam (14), wherein two ends of the first horizontal beam (11) are respectively connected with one end of the second horizontal beam (12) and one end of the fourth horizontal beam (14) in an angle, another end of the second horizontal beam (12) being connected with one end of the third horizontal beam (13) in an angle, another end of the third horizontal beam (13) being connected with another end of the fourth horizontal beam 14 in an angle, in order to form a quadrilateral beam;
a vertical frame (2), having a first vertical beam (21), a second vertical beam (22), a third vertical beam (23), and a fourth vertical beam (24), wherein one end of the first vertical beam (21) is simultaneously connected with the first horizontal beam (11) and the fourth horizontal beam (14) in 90-degree, one end of the second vertical beam (22) being simultaneously connected with the first horizontal beam (11) and the second horizontal beam (12) in 90-degree, one end of the third vertical beam (23) being simultaneously connected with the second horizontal beam (12) and the third horizontal beam (13) in 90-degree, one end of the fourth beam (24) being simultaneously connected with the third horizontal beam (13) and the fourth horizontal beam (14) in 90-degree;
a first pedestal (4), disposed on the horizontal frame (1);
an elevating device (5), disposed on the first pedestal 4, and having a first elevating structure (51) and a second elevating structure (52), which are vertical to the first pedestal (4) respectively and symmetrically distributed on the first pedestal (4), a driving transmission rod (53) and a driven transmission rod (54) being between the two elevating structures (51), (52), and the driving transmission rod (53) and the driven transmission rod (54) being connected to the two elevating structures (51), (52) respectively, a power cylinder (55) disposed on the first pedestal (4) transferring power to the driving transmission rod (53) via a transmission crank (56), the driving transmission rod (53) thus outputting the power to the first elevating structure (51) and the second elevating structure (52), continuously, the driven transmission rod (54) being driven to lift up and lower down the two elevating structures (51), (52); and
a set of adjustment stand (6), having a first adjustment stand (61), a second adjustment stand (62), a third adjustment stand (63), and a fourth adjustment stand (64), which are individually disposed at four bottom portions of the first vertical beam (21), the second vertical beam (22), the third vertical beam (23), and the fourth vertical beam (24), and the four bottom portions being firmly connected with a plurality of ends of the first horizontal beam (11), the second horizontal beam (12), the third horizontal beam (13), and the fourth horizontal beam (14).

2. The elevating system according to claim 1, wherein the two ends of the first horizontal beam (11) are respectively connected with the end of the second horizontal beam (12) and the end of the fourth horizontal beam (14) in the angle, which is 90-degree, the other end of the second horizontal beam (12) being connected with the other end of the third horizontal beam (13) in the angle, which is 90-degree, the other end of the third horizontal beam (13) being connected with the other end of the fourth horizontal beam (14) in the angle, which is 90-degree.

3. The elevating system according to claim 1, wherein the power cylinder (55) is selected from the group consisting of: hydraulic cylinder, electric cylinder and pneumatic cylinder.

4. The elevating system according to claim 1 further comprising a horizontal reinforcement frame (3), which comprises a first horizontal reinforcement rib (31) and a second horizontal reinforcement rib (32), the two horizontal reinforcement ribs (31), (32) being parallel to each other and to the first horizontal beam (11) and the third horizontal beam (13), and the two horizontal reinforcement ribs (31), (32) being parallel to the second horizontal beam (12) and the fourth horizontal beam (14), the first pedestal (4) being firmly disposed on the horizontal reinforcement frame (3); and a set of fixed base (7), which is connected with the first horizontal beam (11), the second horizontal beam (12), the third horizontal beam (13), and the fourth horizontal beam (14), one end of the first adjustment stand (61) being disposed at the bottom portion of the first vertical beam (21), and another end being contacted with ground and connected with the first horizontal beam (11) and the fourth horizontal beam (14); one end of the second adjustment stand (62) being disposed at the bottom portion of the second vertical beam (22), and another end being contacted with the ground and connected with the first horizontal beam (11) and the second horizontal beam (12); one end of the third adjustment stand (63) being disposed at the bottom portion of the third vertical beam (23), and another end being contacted with the ground and connected with the second horizontal beam (12) and the third horizontal beam (13); and one end of the fourth adjustment stand (64) being disposed at the bottom portion of the fourth vertical beam (24), and another end being contacted with the ground and connected with the third horizontal beam (13) and the fourth horizontal beam (14).

5. The elevating system according to claim 4, wherein the two horizontal reinforcement ribs (31), (32) are vertical to each other and to the first horizontal beam (11) and the third horizontal beam (13), and the two horizontal reinforcement ribs (31), (32) being parallel to the second horizontal beam (12) and the fourth horizontal beam (14).

6. The elevating system according to claim 1, wherein the first elevating structure (51) and the second elevating structure (52) respectively have a first pivot outer arm (511) and a first pivot inner arm (512) and a second pivot outer arm (521) and a second pivot inner arm (522), the first pivot outer arm (511) and the first pivot inner arm (512) being pivotally connected to each other at a first pivot point (515), in order to achieve the first elevating structure (51) to perform scissor-like movements, the second pivot outer arm (521) and the second pivot inner arm (522) being pivotally connected to each other at a second pivot point (525), in order to achieve the second elevating structure (52) to perform scissor-like movements, two ends of the driven rod (54) being respectively connected with the first pivot inner arm (512) and the second pivot inner arm (522), and the first pivot outer arm (511) and the second pivot outer arm (521), the power cylinder (55) driving the driving transmission rod (53) in order to drive the first pivot inner arm (512) and the second pivot inner arm (522), so that the first elevating structure (51) and the second elevating structure (52) are able to lift up and lower down simultaneously.

7. The elevating system according to claim 6, wherein the first pivot outer arm (511) has a first pivot outer arm end (5111) and a first pivot outer arm movable end (5113), the first pivot outer arm end (5111) being pivoted to a first pivot outer arm fixed end (5112), and the first pivot outer arm fixed end (5112) being fixed on a first pivot upper plate (516) that is above the first pivot outer arm fixed end (5112), accordingly, the first pivot outer arm fixed end (5112) being a pivotal point of the first pivot outer arm (511), that is to say the first pivot outer arm fixed end (5112) is a central point for the first pivot outer arm (511) to swing, the first pivot outer arm movable end (5113) being pivoted to a first pivot outer arm movable structure (5114), which moves back and forth in a first lower limit structure (514) fixed on the first pedestal (4), the first lower limit structure (514) being structured by two vertical plates (5141) and a horizontal plate (5142) as a n-type structure, wherein two lower ends of the two vertical plates (5141) are fixed on the first pedestal (4), two upper ends of the two vertical plates (5141) being fixed on two ends of the horizontal plate (5142), the first pivot outer arm movable structure (5114) having a bearing, which rolls on the first pedestal (4) back and forth.

8. The elevating system according to claim 6, wherein the first pivot inner arm (512) has a first pivot inner arm end (5121) and a first pivot inner arm movable end (5123), the first pivot inner arm end (5121) being pivoted to a first pivot inner arm fixed end (5122), and the first pivot inner arm fixed end (5122) being fixed on the first pedestal (4), accordingly, the first pivot inner arm fixed end (5122) being a pivotal point of the first pivot inner arm (512), that is to say the first pivot inner arm end (5122) is a central point for the first pivot inner arm (512) to swing, the first pivot inner arm movable end (5123) being pivoted to a first pivot inner arm movable structure (5124), which moves back and forth in a first upper limit structure (513) fixed on the first pivot upper plate (516), the first upper limit structure (513) being structured by two vertical plates (5131) and a horizontal plate (5132) as a n-type structure, wherein two upper ends of the two vertical plates (5131) are fixed on the first pivot upper plate (516), and two lower ends of the two vertical plates (5131) being fixed on two ends of the horizontal plate (5132), the first pivot inner arm movable structure (5124) having a bearing, which rolls on the horizontal plate back and forth.

9. The elevating system according to claim 6, wherein the second pivot outer arm (521) has a second pivot outer arm end (5211) and a second pivot outer arm movable end (5213), the second pivot outer arm end (5211) being pivoted to a second pivot outer arm fixed end (5212), and the second pivot outer arm fixed end (5212) being fixed on a second pivot upper plate (526) that is above the second pivot outer arm fixed end (5212), accordingly, the second pivot outer arm fixed end (5212) being a pivotal point of the second pivot outer arm (521), that is to say the second pivot outer arm fixed end (5212) is a central point for the second pivot outer arm (521) to swing, the second pivot outer arm movable end (5213) being pivoted to a second pivot outer arm movable structure (5214), which moves back and forth in a second lower limit structure (524) fixed on the first pedestal (4), the second lower limit structure (524) being structured by two vertical plates (5241) and a horizontal plate (5242) as a n-type structure, wherein two lower ends of the two vertical plates (5241) are fixed on the first pedestal (4), and two upper ends of the two vertical plates (5241) being fixed on two ends of the horizontal plate (5242), the second pivot outer arm movable structure (5214) having a bearing, which rolls on the first pedestal (4) back and forth.

10. The elevating system according to claim 6, wherein the second pivot inner arm (522) has a second pivot inner arm end (5221) and a second pivot inner arm movable end (5223), the second pivot inner arm end (5221) being pivoted to a second pivot inner arm fixed end (5222), and the second pivot inner arm fixed end (5222) being fixed on the first pedestal (4), accordingly, the second pivot inner arm fixed end (5222) being a pivotal point of the second pivot inner arm (522), that is to say the second pivot inner arm end (5222) is a central point for the second pivot inner arm (522) to swing, the second pivot inner arm movable end (5223) beings pivoted to a second pivot inner arm movable structure (5224), which moves back and forth in a second upper limit structure (523) fixed on the second pivot upper plate (526), the second upper limit structure (523) being structured by two vertical plates (5231) and a horizontal plate (5232) as a n-type structure, wherein two upper ends of the two vertical plates (5231) are fixed on the second pivot upper plate (526), and two lower ends of the two vertical plates (5231) being fixed on two ends of the horizontal plate (5232), the second pivot inner arm movable structure (5224) having a bearing, which rolls on the horizontal plate (5232) back and forth.

11. The elevating system according to claim 1 further comprising a set of fixed base (7), which are a first fixed base (71), a second fixed base (72), a third fixed base (73), and fourth fixed base (74), one end of the first fixed base (71) being disposed at one side of the first vertical beam (21), and another end of the first fixed base (71) being contacted with ground and connected with the first horizontal beam (11) and the fourth horizontal beam (14), one end of the second fixed base (72) being disposed at one side of the second vertical beam (22), and another end of the second fixed base (72) being contacted with the ground and connected with the first horizontal beam (11) and the second horizontal beam (12), one end of the third fixed base (73) beings disposed at one side of the third vertical beam (23), and another end of the third fixed base (73) being contacted with the ground and connected with the second horizontal beam (12) and the third horizontal beam (13), and one end of the fourth fixed base (74) being disposed at one side of the third vertical beam (24), and another end of the fourth fixed base (74) being contacted with the ground and connected with the third horizontal beam (13) and the fourth horizontal beam (14).

12. The elevating system according to claim 1, further comprising a plurality of fixed devices (W,X,Y,Z), which are a first fixed device (W), a second fixed device (X), a third fixed device (Y), and a fourth fixed device (Z), wherein the first fixed device (W) and the second fixed device (X) are respectively disposed on the two first convex blocks (5711) of the first elevating processing part bearing seat (571), and the first elevating processing part bearing seat (571) being above and parallel to the first pivot upper plate (516), the third fixed device (Y) and the fourth fixed device (Z) being respectively disposed on the two second convex blocks (5721) of the second elevating processing part bearing seat (572), and the second elevating processing part bearing seat (572) being above and parallel to the second pivot upper plate (526).

13. The elevating system according to claim 12, wherein each of the fixed devices (W,X,Y,Z) has a positioning cylinder (W1,X1,Y1,Z1), a fixed connecting structure (W2,X2,Y2,Z2), a positioning telescopic rod (W3,X3,Y3,Z3), and a positioning fixed structure (W4,X4,Y4,Z4), one end of each of the positioning telescopic rods (W3,X3,Y3,Z3) being telescopic up and down in each of the positioning cylinders (W1,X1,Y1,Z1), and another end being connected with one side of each of the fixed connecting structures (W2,X2,Y2,Z2), wherein each of the fixed connecting structures (W2,X2,Y2,Z2) is shaped as a plate, each of the column-type positioning fixed structures (W4,X4,Y4,Z4) being disposed beneath another side of each of the fixed connecting structure (W2,X2,Y2,Z2).

14. The elevating system according to claim 13, wherein the first fixed device (W) has a first positioning cylinder (W1), a first fixed connecting structure (W2), a first positioning telescopic rod (W3), and a first positioning fixed structure (W4), one end of the first positioning telescopic rod (W3) being telescopic up and down in the first positioning cylinder (W1), and another end being connected with one side of the first fixed connecting structure (W2), wherein the first fixed connecting structure (W2) is shaped as a plate, the column-type first positioning fixed structure (W4) being disposed beneath another side of the first fixed connecting structure (W2), when a elevated floor to be processed is moved to a position where is above the first elevating processing part bearing seat (571) and the second elevating processing part bearing seat (572), the elevating device (5) being lifted up to dispose the elevated floor to be processed on the first elevating processing part bearing seat (571) and the second elevating processing part bearing seat (572), after the elevated floor to be processed is positioned, at the same time, the first fixed device (W) and the first positioning telescopic rod (W3) also changing a height in accordance with a processing height, and the first positioning fixed structure (W4) also pressing against a corner of the elevated floor to be processed.

15. The elevating system according to claim 13, wherein the second fixed device (X) has a second positioning cylinder (X1), a second fixed connecting structure (X2), a second positioning telescopic rod (X3), and a second positioning fixed structure (X4), one end of the second positioning telescopic rod (X3) being telescopic up and down in the second positioning cylinder (X1), and another end being connected with one side of the second fixed connecting structure (X2), wherein the second fixed connecting structure (X2) is shaped as a plate, the column-type second positioning fixed structure (X4) being disposed beneath another side of the second fixed connecting structure (X2), when a elevated floor to be processed is moved to a position where is above the first elevating processing part bearing seat (571) and the second elevating processing part bearing seat (572), the elevating device (5) being lifted up to dispose the elevated floor to be processed on the first elevating processing part bearing seat (571) and the second elevating processing part bearing seat (572), after the elevated floor to be processed is positioned, at the same time, the second fixed device (X) and the second positioning telescopic rod (X3) also changing a height in accordance with a processing height, and the second positioning fixed structure (X4) also pressing against a corner of the elevated floor to be processed.

16. The elevating system according to claim 13, wherein the third fixed device (Y) has a third positioning cylinder (Y1), a third fixed connecting structure (Y2), a third positioning telescopic rod (Y3), and a third positioning fixed structure (Y4), one end of the third positioning telescopic rod (Y3) being telescopic up and down in the third positioning cylinder (Y1), and another end being connected with one side of the third fixed connecting structure (Y2), wherein the third fixed connecting structure (Y2) is shaped as a plate, the column-type third positioning fixed structure (Y4) being disposed beneath another side of the third fixed connecting structure (Y2), when a elevated floor to be processed is moved to a position where is above the first elevating processing part bearing seat (571) and the second elevating processing part bearing seat (572), the elevating device (5) being lifted up to dispose the elevated floor to be processed on the first elevating processing part bearing seat (571) and the second elevating processing part bearing seat (572), after the elevated floor to be processed is positioned, at the same time, the third fixed device (Y) and the third positioning telescopic rod (Y3) also changing a height in accordance with a processing height, and the third positioning fixed structure (Y4) also pressing against a corner of the elevated floor to be processed.

17. The elevating system according to claim 13, wherein the fourth fixed device (Z) has a fourth positioning cylinder (Z1), a fourth fixed connecting structure (Z2), a fourth positioning telescopic rod (Z3), and a fourth positioning fixed structure (Z4), one end of the fourth positioning telescopic rod (Z3) being telescopic up and down in the fourth positioning cylinder (Z1), and another end being connected with one side of the fixed connecting structure (Z2), wherein the fourth fixed connecting structure (Z2) is shaped as a plate, the column-type fourth positioning fixed structure (Z4) being disposed beneath another side of the fourth fixed connecting structure (Z2), when a elevated floor to be processed is moved to a position where is above the first elevating processing part bearing seat (571) and the second elevating processing part bearing seat (572), the elevating device (5) being lifted up to dispose the elevated floor to be processed on the first elevating processing part bearing seat (571) and the second elevating processing part bearing seat (572), after the elevated floor to be processed is positioned, at the same time, the fourth fixed device (Z) and the fourth positioning telescopic rod (Z3) changing a height in accordance with a processing height, and the fourth positioning fixed structure (Z4) also pressing against a corner of the elevated floor to be processed.

18. The elevating system according to claim 1, further comprising a second pedestal (1A), which is disposed on the first vertical beam (21), the second vertical beam (22), the third vertical beam (23), and the fourth vertical beam (24), the first vertical beam (22) being simultaneously and firmly connected with the first horizontal beam (11) and the fourth horizontal beam (14), the second vertical beam (22) being simultaneously and firmly connected with the first horizontal beam (11) and the second horizontal beam (12), the third vertical beam (23) being simultaneously and firmly connected with the second horizontal beam (12) and the third horizontal beam (13), the fourth vertical beam (24) being simultaneously and firmly connected with the third horizontal beam (13) and the fourth horizontal beam (14), the second pedestal (1A) also having an open 1A1, which allows the elevating device (5) going through when the elevating device (5) is being lifted up to a certain height and lowered down to the first pedestal (4).

19. The elevating system according to claim 12, wherein the first elevating processing part bearing seat (571) and the second elevating processing part bearing seat (572) are parallel to each other.

20. The elevating system according to claim 12, wherein the first elevating processing part bearing seat (571) and the second elevating processing part bearing seat (572) are respectively fixed to two positions where are above the first pivot upper plate (516) and the second pivot upper plate (517).
